(19) United States
(12) Patent Application Publication
(10) Pub. No.: US 2024/0318989 A1
(43) Pub. Date: Sep. 26, 2024

(54) MEASUREMENT SYSTEM FOR MEASURING A FLOW PARAMETER OF A FLUID MEASUREMENT SUBSTANCE FLOWING IN A PIPELINE

(71) Applicant: Endress+Hauser Flowtec AG, Reinach (CH)

(72) Inventors: Anton Rieger, Herrischried (DE); Rainer Höcker, Waldshut (DE); Marc Hollmach, Basel (CH)

(21) Appl. No.: 18/577,546

(22) PCT Filed: Jul. 4, 2022
(86) PCT No.: PCT/EP2022/068376

§ 371 Date: Jan. 8, 2024

(30) Foreign Application Priority Data
Jul. 8, 2021 (DE) 10 2021 117 707.3

(51) Int. Cl. G01F 1/32; G01F 1/325

(52) U.S. Cl. CPC G01F 1/3218; G01F 1/3266; G01F 1/3287

(57) ABSTRACT

A measurement system includes: a pipe insertable into the course of a pipeline; a bluff body arranged in the pipe and configured to generate vortices having a shedding frequency dependent on an instantaneous flow velocity of a fluid such that a Kármán vortex street is formed in the fluid flowing downstream of the bluff body; a vortex sensor arranged downstream of the bluff body, having a resonance frequency and configured to effect mechanical oscillations as to provide a vortex sensor signal including a first component representing oscillations of the vortex sensor with the shedding frequency and a second component representing the mechanical resonance frequency of the vortex sensor; and converter electronics for evaluating the vortex sensor signal and configured to determine whether and/or to what extent the fluid contains foreign substances and/or is a single- or multi-phase substance based on the first and second components of the vortex sensor signal.

The invention relates to a measurement system for measuring at least one flow parameter of a fluid measurement substance flowing in a pipeline.

In process measurement and automation technology, measurement systems designed as vortex flow meters are often used for the measurement of flow velocities of fluid measurement substances flowing in pipelines, in particular, fast-flowing and/or hot gases and/or fluid flows of high Reynolds number, or of flow parameters corresponding to a respective flow velocity, such as volume flow rates or mass flow rates or totaled 11 volume flows or mass flows. Examples of such measurement systems are known, inter alia, from DE-A 10 2005 003631, EP-A 666 467, US-A 2006/0230841, US-A 2008/0072686, US-A 2011/0154913, US-A 2011/0247430, US-A 2011/0314929, US-A 2013/0282309, US-A 2016/0041016, US-A 2017/0284841, US-A 60 03 384, US-A 61 01 885, US-B 63 52 000, US-B 69 10 387, US-B 69 38 496, US-B 80 10 312, US-B 82 00 450, US-B 83 70 098, US-B 84 47 536, WO-A 98/43051, WO-A 2011/043667, WO-A 2017/153124, WO-A 2019/245645 or WO-A 2020/120060 and are also offered, inter alia, by the applicant, for example, under the trade name “PROWIRL D 200”, “PROWIRL F 200”, “PROWIRL O 200”, “PROWIRL R 200.”

Each of the measurement systems shown has a bluff body, which protrudes into the lumen of the respective pipeline, for example, namely designed as a system component of a heat supply network or of a turbine circuit or into a lumen of a measurement pipe used in the course of said pipeline, against which bluff body the measurement substance, for example, (liquid) water or (hot) steam, flows to generate vortices that are lined up to form a so-called Karman vortex street within the partial volume of the fluid flow flowing directly downstream of the bluff body. As is known, the vortices are generated at the bluff body at a shedding frequency (fv) that depends on the flow velocity of the fluid flowing through the measurement pipe in a main flow direction and, with the Strouhal number (Sr˜fv/u) as a proportionality factor, is proportional to the flow velocity (u) of the fluid flowing passed the bluff body, at least for high Reynolds numbers (Re) of more than 20,000. Furthermore, the measurement systems have a vortex sensor protruding into the flow and therefore into lumens of the region of the Kármán vortex street, for example, positioned downstream of the bluff body or integrated therein. Said vortex sensor is used in particular to sense pressure fluctuations in the Karman vortex street formed in the flowing measurement substance and to convert them into a vortex sensor signal, for example, an electrical or optical vortex sensor signal, which represents the pressure fluctuations and corresponds to a pressure prevailing within the measurement substance and subject to periodic fluctuations downstream of the, typically, prismatic or cylindrical bluff body as a result of vortices in the opposite direction, such that the vortex sensor signal contains a useful component, namely a spectral signal component having an amplitude that represents the shedding frequency and at the same time differs significantly from the signal noise.

In the case of the measurement system disclosed in each of US-B 63 52 000, US-A 2006/0230841 or US-A 2017/0284841, the vortex sensor has a sensor assembly formed by means of a deformation element, usually in the form of a thin and substantially flat diaphragm, and a, usually planar or wedge-shaped, sensor lug that extends from a substantially planar surface of said deformation element, said sensor assembly being configured to sense pressure fluctuations effective in a detection direction transversely to the actual main flow direction in the Kármán vortex street, namely to convert them into movements of the deformation element corresponding to the pressure fluctuations such that the sensor lug, as a result of the pressure fluctuations, executes pendular movements in the detection direction that elastically deform the deformation element, as a result of which the deformation element and the sensor lug are excited into forced, but non-resonant, oscillations, typically namely below a lowest mechanical resonance frequency of the vortex sensor, around a common static rest position. The deformation element further has a usually circular-ring-shaped outer edge segment, which is configured to be hermetically sealed, for example, integrally bonded, to a socket that is used to hold the deformation element and the sensor formed therewith on the wall of a pipe such that the deformation element covers and hermetically seals an opening provided in the wall of the pipe and that the surface of the deformation element supporting the sensor lug faces the measurement-substance-carrying lumen of the measurement pipe or the pipeline, and therefore the sensor lug projects into said lumen. In order to generate the vortex sensor signal, the vortex sensor further comprises a corresponding transducer element, which is for example, formed specifically by means of a capacitor mechanically coupled to the sensor assembly or integrated therein or by means of a piezoelectric stack acting as a piezoelectric transducer and is configured to detect movements of the deformation element, not least also movements of the deformation element corresponding to pressure fluctuations, or of the compensating element that may be present, and to modulate them to form an electrical or optical carrier signal. As shown, inter alia, in US-B 63 52 000 or US-A 2017/0284841, the sensor assemblies or the vortex sensor formed therewith can also have a usually rod-shaped, planar or sleeve-shaped compensating element that extends from a surface of the deformation element facing away from the surface supporting the sensor lug and is used in particular to compensate for forces or moments resulting from movements of the sensor assembly, for example, as a result of vibrations of the pipeline, or to avoid undesired movements of the sensor lug resulting therefrom.

On a side facing away from the measurement-substance-carrying lumen, the vortex sensor is furthermore connected to converter electronics, which are typically encapsulated in a pressure-tight and impact-proof manner and optionally also hermetically sealed towards the outside. The converter electronics have a corresponding digital measurement circuit, which is electrically connected to the vortex sensor or its transducer element via connection lines, optionally with the interposition of electrical barriers and/or galvanic isolation points, for processing or evaluating the vortex sensor signal and for generating digital measurement values for the flow parameter to be detected in each case, for example, the flow speed, the volume flow rate and/or the mass flow rate. In particular, the converter electronics are configured to determine digital vortex frequency measurement values representing the shedding frequency using the at least one vortex sensor signal and to calculate, using one or more vortex frequency measurement values, measurement values for the at least one flow parameter and to output same, for example, to a display element provided correspondingly in the measurement system. As is also shown in the aforementioned documents US-B 69 38 496, US-B 69 10 387, US-B 80 10 312, US-B 82 00 450, US-B 83 70 098 or US-B 84 47 536, measurement systems of the type in question can also have a temperature sensor, for example, arranged downstream of the bluff body or therein, and/or a pressure sensor, for example, arranged downstream of the bluff body or therein, and the converter electronics can additionally be configured to calculate measurement values for the at least one flow parameter also using a temperature sensor signal provided by the temperature sensor or using a pressure sensor signal provided by the pressure sensor. The converter electronics, usually accommodated in a protective housing made of metal and/or impact-resistant plastic, of measurement systems suitable for industry or established in industrial measurement technology also usually provide external interfaces conforming to an industry standard, for example, DIN IEC 60381-1, for communication with higher-level measurement and/or regulator systems, for example, formed by means of programmable-logic controllers (PLC). Such an external interface can be designed, for example, as a two-wire connection that can be incorporated into a current loop and/or be compatible with established industrial field buses.

As discussed in the aforementioned documents US-A 2016/0041016, US-A 2013/0282309 and US-A 2011/0314929, the flow measurement values determined by means of measurement systems of the type in question can be considerably flawed in the event, which cannot regularly be ruled out, that the measurement substance contains also foreign substances; this applies not least also in the frequently occurring event that gas entrapped in the otherwise liquid measurement substance is carried therein, for example, in the form of gas bubbles, or that measurement substance and foreign substance(s) form a bubble flow, and/or such that the presence of foreign substances is not detected or is detected late by the converter electronics.

Proceeding from the aforementioned prior art, one object of the invention is to improve measurement systems of the aforementioned type to the effect that at least the occurrence of foreign substances causing increased measurement errors can be detected early in a flowing measurement substance and/or that measurement errors caused by foreign substances in the measurement substance can be reduced.

To achieve the object, the invention comprises in a measurement system for measuring at least one flow parameter, for example, a time-variable flow parameter, for example, a flow velocity and/or a volume flow rate and/or a mass flow rate, of a, for example, at least occasionally single-phase and/or at least occasionally multi-phase fluid measurement substance, for example, a gas, a liquid, or a dispersion, flowing in a pipeline, which measurement system comprises:
a pipe insertable into the course of said pipeline and having a lumen, which is configured to guide the measurement substance flowing in the pipeline or to allow said measurement substance to flow through it;
a, for example, prismatic or cylindrical bluff body arranged in the lumen of the pipe, which bluff body is configured to generate, in the measurement substance flowing passed it, vortices having a shedding frequency (fv˜u) dependent on an instantaneous flow velocity (u) of said measurement substance, in such a way that a Kármán vortex street is formed in the fluid flowing downstream of the bluff body;
a vortex sensor arranged downstream of the bluff body, said vortex sensor having at least one mechanical resonance frequency (f_{R}) which is, for example, a lowest mechanical resonance frequency and/or lies always above the shedding frequency, and being configured, in a manner excited by the flowing measurement substance, to effect mechanical oscillations around a static rest position and to provide at least one, for example, electrical or optical, vortex sensor signal which represents said oscillations and which contains a first useful component, namely a first spectral signal component (vortex component) representing oscillations of the vortex sensor with the shedding frequency (fv), for example, one with a signal level not below a predetermined threshold value for signal noise, and which contains a second useful component, namely a second spectral signal component (resonance component) representing resonance oscillations of the vortex sensor with the mechanical resonance frequency (f_{R}) thereof, for example, one with a signal level not below a predetermined threshold value for signal noise;
and converter electronics, for example, formed by means of at least one microprocessor, for evaluating the at least one vortex sensor signal and for determining measurement values, for example, digital measurement values, for the at least one flow parameter;
wherein the converter electronics are configured to receive and evaluate the at least one vortex sensor signal, namely to determine at least on the basis of the first useful component of the at least one vortex sensor signal, for example, digital, vortex frequency measurement values representing the shedding frequency, and also to determine on the basis of the second useful component of the at least one vortex sensor signal, for example, digital, amplitude measurement values representing an amplitude of the resonance oscillations of the vortex sensor;
and wherein the converter electronics are furthermore configured, using one or more amplitude measurement values, to determine whether and/or to what extent the measurement substance contains foreign substances, for example, gas inclusions (bubbles) entrained in a liquid, and/or to determine whether the measurement substance is embodied as a single- or multi-phase substance, and also, using one or more vortex frequency measurement values, to calculate, for example, digital, flow parameter measurement values, namely measurement values for the at least one flow parameter.

According to a first embodiment of the invention, it is further provided for the converter electronics to be configured to calculate the flow parameter measurement values also using a Strouhal number (Sr˜fv/u), namely a characteristic number representing a ratio of the shedding frequency (fv) to the flow velocity (u) of the fluid flowing passed the bluff body.

According to a second embodiment of the invention, it is further provided for the converter electronics to be configured to calculate the flow parameter measurement values in each case also using one or more amplitude measurement values, at least in case of a two-phase measurement substance.

According to a third embodiment of the invention, it is further provided for the converter electronics to be configured to calculate, using at least one of the amplitude measurement values, for example, also using at least one of the vortex frequency measurement values, a characteristic number value for a flow characteristic characterizing a ratio of a static pressure (pₛₜₐₜ) acting on the vortex sensor in a direction extending transversely to an imaginary longitudinal axis of the measurement pipe to a dynamic pressure (p_{dyn}) acting on the vortex sensor in the direction of the imaginary longitudinal axis of the measurement pipe, for example, in such a way that the flow characteristic corresponds to a pressure coefficient of the vortex sensor, to an Euler number, or to a cavitation number of the measurement substance. In further developing this embodiment of the invention, the converter electronics are further configured to compare the characteristic number value with at least one threshold value, determined for example, in advance under reference conditions and/or on the basis of the vortex sensor signal, which threshold value represents a, for example, maximum permissible and/or critical, foreign substance proportion specified for the measurement system and/or the measurement substance. For example, the converter electronics can also be configured to determine the threshold value on the basis of the vortex sensor signal, namely, for example, using at least one of the vortex frequency measurement values, and/or to output a message, for example, a message that is visually and/or acoustically perceivable on site and/or encoded into a data signal and/or declared as an alarm, if the characteristic number value has exceeded the at least one threshold value. Alternatively or additionally, the at least one threshold value can correspond to a characteristic number value determined in advance under reference conditions, namely for a calibration fluid, for example, a single-phase calibration fluid, such as water, which flows through the transducer.

According to a fourth embodiment of the invention, it is further provided for the converter electronics to have a first signal filter configured to receive the vortex sensor signal at a signal input and to provide, at a filter output, a first, for example, digital, useful signal containing the first useful component of the vortex sensor signal, for example, namely containing the second useful component only in attenuated form or not at all, and/or to have a second signal filter configured to receive the vortex sensor signal at a signal input and to provide, at a filter output, a second, for example, digital, useful signal containing the second useful component of the vortex sensor signal, for example, namely containing the first useful component only in attenuated form or not at all. In further developing this embodiment of the invention, the converter electronics are further configured to determine the vortex frequency measurement values using the first useful signal and/or the amplitude measurement values using the second useful signal.

According to a fifth embodiment of the invention, it is further provided for the converter electronics to be configured to generate a discrete Fourier transform (DFT) of the at least one vortex sensor signal and to determine the vortex frequency measurement values and/or the amplitude measurement values on the basis of said discrete Fourier transform of the at least one vortex sensor signal.

According to a sixth embodiment of the invention, it is further provided for the converter electronics to be configured to calculate an autocorrelation (AKF) of the at least one vortex sensor signal and to determine the vortex frequency measurement values on the basis of said autocorrelation of the at least one vortex sensor signal.

According to a seventh embodiment of the invention, it is further provided for the converter electronics to have at least one converter circuit, which is configured to receive and digitize the at least one vortex sensor signal, for example, namely to convert it into a digital vortex sensor signal and to provide said digital vortex sensor signal at a digital output of the converter circuit.

According to an eighth embodiment of the invention, it is further provided for the vortex sensor to have a deformation element, for example, a diaphragm-like and/or disk-shaped deformation element, with a first surface facing the lumen and an opposite second surface, for example, arranged at least partially parallel to the first surface, and at least one transducer element, which is arranged above and/or on the second surface of the deformation element, for example, namely attached to the deformation element and/or positioned in the vicinity thereof, which transducer element is configured to detect movements of the deformation element, for example, of the second surface thereof, and convert them into the vortex sensor signal. In further developing this embodiment, the vortex sensor has a sensor lug, for example, a planar or wedge-shaped sensor lug, extending from the first surface of the deformation element to a distal end.

According to a further embodiment of the invention, it is further provided for the measurement system to comprise a display element coupled to the converter electronics for outputting measurement values provided by the converter electronics for the at least one flow parameter and/or messages generated by means of the converter electronics.

One basic idea of the invention is to detect the (oscillation) amplitude, which is correlated with the foreign substance proportion, of the resonance oscillations of the vortex sensor excited by the flowing measurement substance which is possibly loaded with foreign substance, and to evaluate it accordingly for the detection of the foreign substance, possibly also for a calculation quantifying the foreign substance proportion. One advantage of the invention can also be seen, inter alia, in that the detection of foreign substance contained in the measurement substance can be set up solely by a corresponding modification of the calculation algorithm, typically implemented as firmware and/or software in the converter electronics of modern measurement systems, for example, even namely added on simply by means of a corresponding upgrade of the firmware or software in the case of already installed measurement systems.

The invention as well as advantageous embodiments thereof are explained in more detail below based upon exemplary embodiments shown in the figures of the drawing. Identical or identically acting or identically functioning parts are provided with the same reference signs in all figures; for reasons of clarity or if it appears sensible for other reasons, reference signs mentioned before are dispensed with in subsequent figures. Further advantageous embodiments or developments, especially, combinations of partial aspects of the invention that were initially explained only separately, furthermore emerge from the figures of the drawing and/or from the claims themselves.

In the figures in detail:

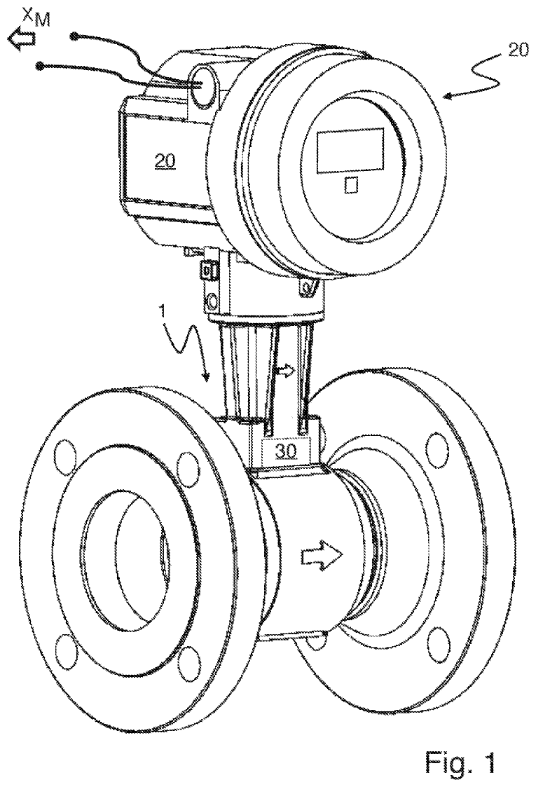

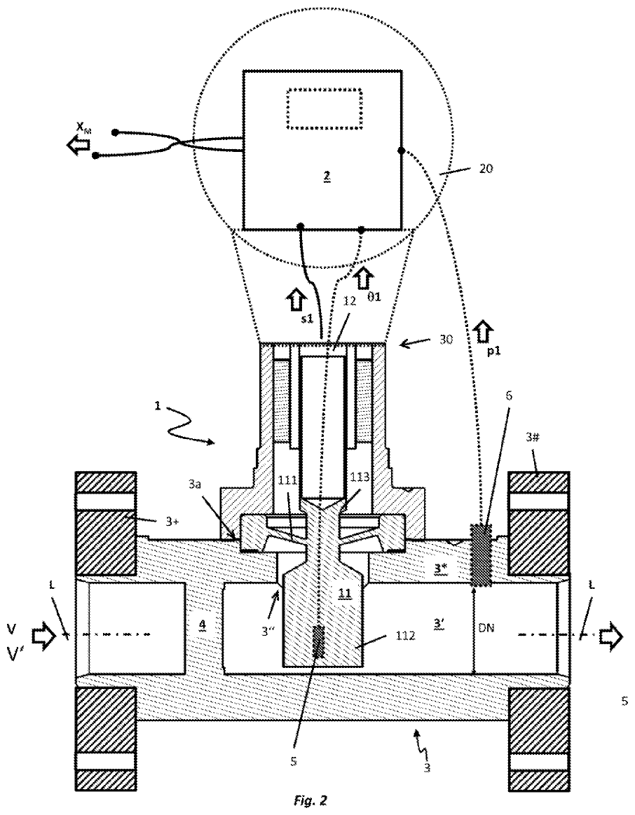

FIGS. 1, 2 show various schematic views of a measurement system, in this case in the form of a vortex flow meter, having a vortex sensor and converter electronics for measuring at least one flow parameter of a fluid flowing in a pipeline;

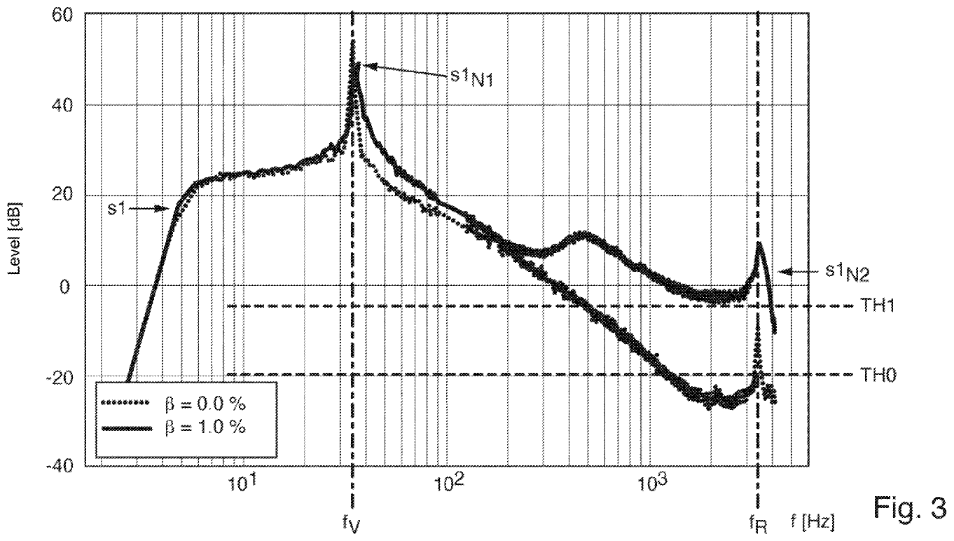

FIG. 3 shows by way of example, power spectral densities of vortex sensor signals generated by means of a measurement system according to FIG. 1 or FIG. 2 with the measurement substance showing different loads of foreign substance (gas bubbles entrained in water); and

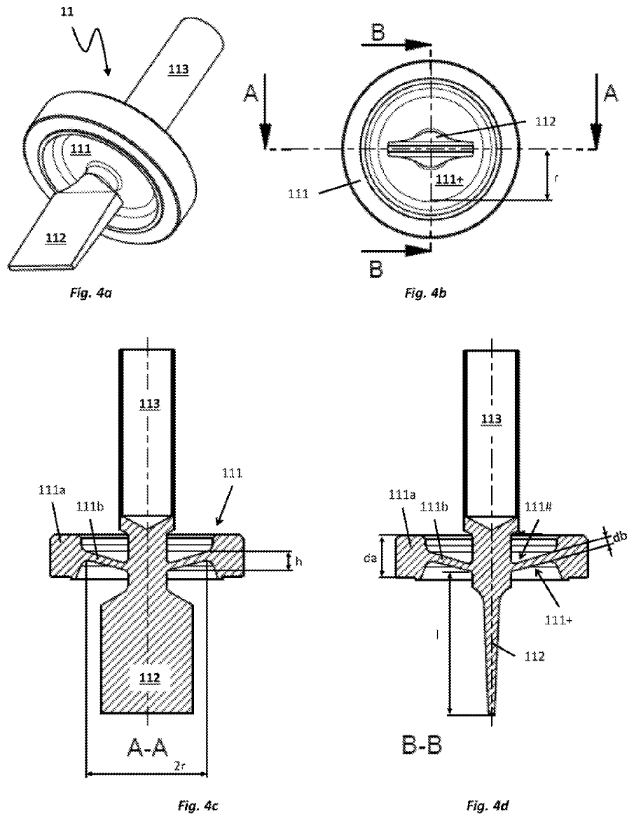

FIGS. 4a, 4b show schematic, partially also cut views an exemplary embodiment of a 4c, 4d vortex sensor suitable for use in a measurement system according to FIGS. 1 and/or FIG. 2.

FIGS. 1 and 2 show an exemplary embodiment of a measurement system for measuring at least one flow parameter, which possibly also varies over time, for example, namely a flow velocity u and/or a volume flow rate and/or mass flow rate, of a fluid measurement substance flowing in a pipeline, for example, a liquid, a gas, or a dispersion. The pipeline can be designed, for example, as a plant component of a potable water network, of a heat supply network or of a turbine circuit, and therefore the measurement substance can be, for example, water or steam, in particular saturated steam or superheated steam, or else, for example, a condensate discharged from a steam line. However, measurement substance can also be, for example, a cryogas, a mineral oil or a (compressed) natural gas or a biogas, so that the pipeline can also be a component of a natural gas or biogas plant or of a gas supply network, for example.

The measurement system comprises a pipe 3 that can be inserted into the course of the aforementioned pipeline and has a lumen 3′ that is surrounded by a wall 3*, for example, a metallic wall, of the pipe and extends from an inlet end 3+ to an outlet end 3# and is configured to guide the fluid flowing in the pipeline and for said fluid to flow through it in the direction of a (main) flow direction of the measurement system defined by an imaginary longitudinal axis of the measurement pipe. In the exemplary embodiment shown here, there is at both the inlet end 3+ and the outlet end 3# a flange, which is used in each case to produce a leak-free flange connection to a respective corresponding flange on an inlet-side or outlet-side line segment of the pipe. Furthermore, as shown in FIG. 1 or 2, the pipe 3 can be substantially straight, for example, namely in the form of a hollow cylinder with a circular cross section, at least in sections, in such a way that the pipe 3 has an imaginary straight longitudinal axis L connecting the inlet end 3+ and the outlet end 3#. The measurement system also has: a bluff body 4, for example, a prismatic or cylindrical bluff body, which is arranged inside the lumen 3′ and is configured to generate vortices in the fluid flowing passed at a shedding frequency fv (fv˜u) dependent on a current flow velocity u of said fluid, such that a Karman vortex street is formed in the fluid flowing downstream of the bluff body; and a vortex sensor 1, which is for example, arranged downstream of the bluff body 4 or is integrated therein, for detecting vortices of the Kármán vortex street, for example, namely periodic pressure fluctuations associated therewith, namely at constant flow velocity u, in the flowing fluid. Said vortex sensor 1 is in particular configured to provide at least one vortex sensor signal s1, in particular an electrical or optical vortex sensor signal, which changes over time, and for example, namely corresponds with the aforementioned pressure fluctuations; this is done in particular in such a manner that the vortex sensor signal s1 contains, as can also be easily seen in FIG. 3, a first useful component s1_{N1} (vortex component), namely a first spectral signal component (@fv) that represents the shedding frequency fv, and for example, is not below a predetermined threshold value TH1 for signal noise, namely having at least a minimum spectral power density or a corresponding minimum amplitude, and/or is not above a threshold value TH2 for signal noise, namely having at most a maximum spectral power density or a corresponding maximum amplitude, if a Kármán vortex street is formed in the fluid flowing downstream of the bluff body. Given that the vortex sensor 1 naturally also has a plurality of natural oscillation modes, of which one or more can be excited during operation of the measurement system, the vortex sensor signal typically also contains, as is also readily apparent from FIG. 3, one or more spectral signal components, which correspond to a respective resonance frequency (f_{R}) of one of the aforementioned oscillation modes. In particular, it has been found that the vortex sensor 1 can also be excited by the fluid flowing passed it to vibrations at one or more of the aforementioned resonance frequencies, or conversely that at least one of the aforementioned vibrations is not excited significantly or at all if no fluid flows passed the vortex sensor. Accordingly, as is also readily apparent from FIG. 3, the vortex sensor signal contains at least temporarily also at least one second useful component s1_{N2} (resonance component), namely a second spectral signal component (@f_{R}), which in particular in respect of a spectral power density or amplitude is not below a predetermined threshold value (TH0) for signal noise and/or is occasionally above a threshold value (TH1) for measurement substance configured as a dispersion or foreign substance entrained in the measurement substance and which represents a mechanical resonance frequency f_{R} of the vortex sensor, for example, namely a lowest resonance frequency and/or a resonance frequency that is always above the shedding frequency fv and/or a resonance frequency of a natural oscillation mode serving to detect the vortices; and in particular this is the case when fluid is flowing passed the vortex sensor and/or this is not the case when there is no fluid flowing passed the vortex sensor.

According to a further embodiment of the invention, the measurement system comprises a temperature sensor 5 that is configured to provide at least one temperature sensor signal θ1 that follows a change in a temperature of the flowing fluid with a change in at least one signal parameter, and/or the measurement system has a pressure sensor 6 that is configured to provide at least one pressure sensor signal p1 that follows a change in a pressure, in particular a static pressure, of the flowing fluid with a change in at least one signal parameter. The temperature sensor can be arranged, for example, downstream of the bluff body, possibly also within the vortex sensor or, as shown schematically in FIG. 2, within the bluff body. Furthermore, the pressure sensor can also be arranged downstream of the resistance element or inside the resistance element, for example.

According to another embodiment of the invention, the vortex sensor 1 is formed, as shown in each of FIG. 2 and FIGS. 4a, 4b, 4c, 4d or as can be seen easily when said figures are viewed together, by means of a deformation element 111, in particular a diaphragm-like or disk-shaped deformation element, and a sensor lug 112 that has a left-hand first side face 112+ and a right-hand second side face 112# and extends from a first surface 111+ of the deformation element 111 to a distal (free) end namely remote from the deformation element 111 and its surface 111+ and is configured for flowing fluid to flow around it. In this case, the vortex sensor and the bluff body are in particular dimensioned and arranged such that the sensor lug 112 projects into the lumen 3* of the pipe or the fluid guided therein in a region usually taken up by the Kármán vortex street when the measurement system is in operation. The deformation element 111 furthermore has a second surface 111# that is opposite the first surface 111+, for example, at least partially parallel to the first surface 111+, and an outer edge segment 111a, which is for example, circular-ring-shaped and/or provided with a sealing face. The outer edge segment 111a has a thickness that, as indicated in FIGS. 2 and 4a, 4b, 4c, 4d, is substantially greater than a minimum thickness of an inner segment 111b enclosed by said edge segment 111a and in this case namely supports the sensor lug 112. The deformation element 111 and the sensor lug 112 are in particular configured to be excited to forced oscillations about a common static rest position in such a way that the sensor lug 112 executes pendular movements that elastically deform the deformation element 111 in a detection direction running substantially transversely to the aforementioned (main) flow direction or transversely to the aforementioned longitudinal axis of the measurement pipe, or oscillation movements according to a natural oscillation mode intrinsic to the vortex sensor. According to a further embodiment of the invention, the sensor lug 112 accordingly has a width b, measured as a maximum extent in the direction of the (main) flow direction, which is substantially greater than a thickness d of the sensor lug 112, measured as a maximum lateral extent in the direction of the detection direction. In the exemplary embodiment shown in FIGS. 4a, 4b, 4c, 4d, the sensor lug 112 is substantially wedge-shaped; however, it can also be designed as a relatively thin flat plate, for example, as is quite usual for such vortex sensors. According to a further embodiment of the invention, the vortex sensor 1 and the pipe 3 are further dimensioned such that a length of the sensor lug 112, measured as the minimum distance between a proximal end of the sensor lug 112, namely the end bordering the deformation element 111 and the distal end of the sensor lug 112, corresponds to more than half of a caliber DN of the pipe 3 and less than 95% of said caliber DN. For example, the length l can also be selected, as is quite usual with a comparatively small caliber of less than 50 mm, in such a way that said distal end of the sensor lug 112 has only a very small minimum distance from the wall 3* of the pipe 3. In the case of pipes with a comparatively large caliber of 50 mm or more, the sensor lug 112 can also, as is quite usual in the case of measurement systems of the type in question or as can also be seen from FIG. 2, be significantly shorter than half of a caliber of the pipe 3, for example. The deformation element 111 and the sensor lug 112 can furthermore be, for example, components of one and the same monolithic molded part that is cast or produced by an additive manufacturing process such as 3D laser melting, for example; however, the deformation element and the sensor lug can also be designed as individual parts that are initially separate from one another and are only subsequently integrally bonded to each other, for example, namely welded or soldered to one another, and therefore produced from materials that can correspondingly be integrally bonded to each other. As is quite usual with such vortex sensors, the deformation element 111 can consist at least partially, for example, namely predominantly or completely, of a metal such as stainless steel or a nickel-based alloy. The sensor lug can likewise consist at least partially of a metal, namely, for example, stainless steel or a nickel-based alloy; the deformation element 111 and the sensor lug 112 can in particular also be produced from the same material. Furthermore, the vortex sensor has a transducer element 12, for example, a capacitive transducer element designed as a piezoelectric transducer, as a component of a capacitor or else for example, an optical transducer element designed as a component of a photodetector, for generating a signal that represents movements of the sensor lug that change over time and are typically namely at least intermittently periodic and at the same time deformations of the deformation element 111 that change over time, and in this case also acts as a vortex sensor signal, for example, a variable electrical voltage modulated by the aforementioned movements or correspondingly modulated laser light. The vortex sensor 1 is also inserted into the pipe 3 in such a way that the first surface of the deformation element 111 faces the lumen 3′ of the pipe, so that the sensor lug projects into said lumen.

In the exemplary embodiment shown in FIGS. 1 and, respectively, 2, the vortex sensor 1 is inserted into the lumen of the pipe from the outside through an opening 3″ formed in the wall and is fixed, for example, also releasably, from the outside to the wall 3* in the region of said opening in such a way that the surface 111+ of the deformation element 111 faces the lumen 3′ of the pipe 3 and therefore the sensor lug 112 protrudes into said lumen. Especially, the sensor 1 is inserted into the opening 3″ in such a way that the deformation element 111 covers or hermetically seals the opening 3″. Said opening can be designed, for example, in such a way that it has, as is quite usual in measurement systems of the type in question, an (inner) diameter in a range between 10 mm and approximately 50 mm. According to a further embodiment of the invention, a socket 3a used to hold the deformation element on the wall 3* is formed in the opening 3″. In this case, the vortex sensor 1 can, for example, be fixed to the pipe 3 by integral bonding, in particular by welding or soldering, of the deformation element 111 and wall 3*; however, it can for example, also be detachably connected to the pipe 3, for example, namely screwed thereto or screwed thereon. Furthermore, at least one sealing face, for example, also a circumferential or circular-ring-shaped sealing face, can be formed in the socket 3a and is configured to seal the opening 3″ correspondingly in cooperation with the deformation element 111 and an optionally provided, for example, annular or annular disk-shaped, sealing element. Not least if the vortex sensor is to be inserted into the aforementioned socket 3a and connected detachably to the pipe 3, the edge segment 111a of the deformation element 111 can advantageously also be provided with a sealing face, which for example, also corresponds with the sealing face possibly provided in the opening 3″ and/or is circular-ring-shaped.

According to a further embodiment of the invention, in order to compensate for forces and/or moments resulting from random movements of the vortex sensor, for example, as a result of vibration of the aforementioned pipeline connected to the pipe, or to avoid undesired movements of the sensor lug or of the deformation element 111 resulting therefrom, namely distorting the sensor signal s1, the vortex sensor 1 further has a compensating element 114, for example, a rod-shaped, planar or sleeve-shaped compensating element, extending from the second surface 111# of the deformation element 111. Said compensating element 114 can also be used as a holder of the transducer element 12 or else be used as a component of the transducer element 12, for example, as a movable electrode of a capacitor forming said (capacitive) transducer element. The compensating element 114 can, for example, consist of the same material as the deformation element and/or the sensor lug, for example, a metal. For example, the compensating element 114 can be produced from stainless steel or a nickel-based alloy. According to a further embodiment of the invention, the deformation element 111 and the compensating element 114 are integrally bonded to one another, for example, welded or soldered to one another, and therefore the compensating element 114 and the deformation element 111 are produced from materials that can be integrally bonded to one another accordingly. Alternatively, however, the deformation element 111 and the compensating element 114 can also be components of one and the same monolithic molded part, for example, also in such a way that the sensor lug 111, the deformation element 112 and the compensating element 114 are components of said molded part. The sensor lug 112 and the compensating element 114 can also be arranged in alignment with one another, as can also be seen by viewing FIGS. 4c and 4d together, in such a way that a main axis of inertia of the sensor lug 112 coincides in extension with a main axis of inertia of the compensating element 114. Alternatively or in addition, the compensating element 114 and the deformation element 111 can also be positioned and aligned with one another such that a main axis of inertia of the deformation element 111 coincides in extension with a main axis of inertia of the compensating element 114. Furthermore, the sensor lug 112, the compensating element 114 and the deformation element 111 can also be positioned and aligned with one another, as can also be seen by viewing FIGS. 2, 4a, 4b, 4c and 4d together, such that a main axis of inertia of the vortex sensor 11 runs parallel to a main axis of inertia of the sensor lug 112 and to a main axis of inertia of the compensating element 114 and also to a main axis of inertia of the deformation element 111 or coincides with a said main axis of inertia of the sensor lug and with said main axis of inertia of the compensating element and also with said main axis of inertia of the deformation element.

For processing or evaluating the at least one vortex sensor signal, the measurement system further comprises converter electronics 2, which is for example, accommodated in a pressure- and/or impact-proof protective housing 20 and is connected to the sensor 1 and communicates with the vortex sensor 1 during operation of the measurement system. The protective housing 20 for the converter electronics 2 can, for example, be produced from a metal, such as stainless steel or aluminum, and/or by means of a casting method, such as an investment casting or die casting method (HPDC); it can however, for example, also be formed by means of a plastic molded part produced in an injection molding method. In the exemplary embodiment shown here, the measurement system is also designed as a compact type vortex flow meter in which the protective housing 20 with the converter electronics 2 accommodated therein is held on the pipe, for example, by means of a neck-like connecting piece 30. The converter electronics 2 formed, for example, by means of at least one microprocessor, is configured, inter alia, to receive and evaluate the vortex sensor signal s1, namely to determine, at least on the basis of its first useful component, for example, digital vortex frequency measurement values X_{f} representing the shedding frequency, and also to calculate, using one or more vortex frequency measurement values X_{f}, flow parameter measurement values X_{M}, for example, also digital flow parameter measurement values X_{M}, namely measurement values for the at least one flow parameter; this is done for example, in such a way that the flow parameter measurement values X_{M} each comply with a calculation rule:

$${X}_{M} = {k}_{1} \cdot {X}_{f}$$

at least in case of a single-phase measurement substance, wherein the coefficient k₁ contained in the aforementioned calculation rule is a calibration factor of the converter electronics or of the measurement system formed therewith which corresponds to the aforementioned Strouhal number (Sr), for example, also a measurement-system-type-specific or measurement-system-series-specific calibration factor. Moreover, the flow parameter measurement values X_{M} can, for example, be visualized in situ and/or be transmitted in a wired manner via a connected field bus and/or in a wireless manner via radio to an electronic data processing system, for example, a programmable logic controller (PLC) and/or a supervisory control and data acquisition (SCADA) station. Accordingly, according to a further embodiment, the measurement system has a display element coupled to its converter electronics 2 and/or at least one data output for outputting data provided by the converter electronics 2, for example, the measurement values X_{M} for the at least one flow parameter, and/or messages generated by means of the converter electronics 2. Not least in case that the converter electronics 2 are provided at least with a microprocessor that is useful for processing the vortex sensor signal and determining digital measurement values that represent the at least one flow parameter, the converter electronics according to yet another embodiment of the invention can have at least one converter circuit A/D which is configured to receive and digitize the at least one vortex sensor signal, in particular to convert it into a digital vortex sensor signal and to provide said digital vortex sensor signal at a digital output of the converter circuit A/D; and/or converter electronics 2 according to another embodiment of the invention can have at least one non-volatile (data) memory (EEPROM) for storing digital measurement and/or operating data, namely, for example, also programs implementing calculation instructions, and/or calibration constants (k₁, k₂) and/or threshold values. In the aforementioned case in which the measurement system has the temperature sensor and/or the pressure sensor, the converter electronics 2 are further configured also to receive the at least one temperature sensor signal and/or the at least one pressure sensor signal, and the converter electronics 2 are also configured to determine, using the at least one temperature sensor signal, temperature measurement values X_{θ} representing the temperature of the fluid and/or to determine, using the at least one pressure sensor signal, pressure measurement values Xₚ representing the pressure of the fluid. The converter electronics 2 can moreover also be configured to take into account the temperature measurement values X_{θ} and/or the pressure measurement values Xₚ when calculating the flow parameter measurement values X_{M}, or to use them when calculating the flow parameter measurement values X_{M}, for example, also in the aforementioned case in which the flow parameter measurement values X_{M} represent a mass flow of the measurement substance.

As already mentioned, the vortex sensor or the measurement system formed thereby is in particular also provided to be used in such an application or plant in which the measurement substance is configured at least occasionally as a dispersion, in particular as a two-phase dispersion, for example, in such a way that gas entrapped in the otherwise liquid measurement substance is entrained therein with a (volume) concentration B, which may also vary over time. For this purpose, the converter electronics 2 are further configured to evaluate the vortex sensor signal s1 also with respect to its second useful component, namely to determine, on the basis of the second useful component, (resonant) amplitude measurement values Xs, for example, also digital (resonant) amplitude measurement values Xs, that represent an amplitude of the resonance oscillations of the vortex sensor 1, and to determine, using one or more amplitude measurement values Xs, at least qualitatively whether the measurement substance is in a single-phase or multi-phase form, whether, for example, gas inclusions (bubbles) are entrained in a liquid, and/or to determine quantitatively to what extent, for example, with which (volume) proportion or with which (volume) concentration B, foreign substances are contained in the measurement substance.

According to yet another embodiment of the invention, the converter electronics 2 are also configured to determine, using at least one of the amplitude measurement values Xₛ, a characteristic number value X_{K} for a flow characteristic SK1 (Eu, σ, cp) characterizing a loading of the measurement substance with at least one foreign substance, namely, for example, a corresponding foreign substance content or a corresponding ratio of the (pulsating) static pressure pₛₜₐₜ (pₛₜₐₜ@fr) acting on the vortex sensor in the detection direction or in the direction transverse to the aforementioned (main) flow direction to a dynamic pressure p_{dyn} (p_{dyn}˜u²˜fv²) (dependent on the flow velocity u) acting on the vortex sensor in the direction of the aforementioned longitudinal axis of the measurement pipe or in the (main) flow direction, and therefore representing a back pressure acting on the vortex sensor; this is done in particular also using at least one of the vortex frequency measurement values X_{f} and/or such that the characteristic number value X_{K} complies with a calculation rule:

$${X}_{K} = {k}_{2} \cdot \frac{Xs \cdot }{{X}_{f}^{2}}$$

and therefore quantifies the aforementioned ratio (pₛₜₐₜ/p_{dyn}) of static pressure pₛₜₐₜ acting on the vortex sensor to dynamic pressure p_{dyn} acting on the vortex sensor. The coefficient k₂ contained in the aforementioned calculation rule (like the aforementioned coefficient k₁) is also a calibration factor of the converter electronics or of the measurement system formed thereby, possibly also a measurement-system-type-specific or measurement-system-series-specific calibration factor, wherein the coefficient k₂ can, for example, advantageously also be selected or set such that in the end the flow characteristic SK1 corresponds to a pressure coefficient (Cp) of the vortex sensor or to an Euler number (Eu) or a cavitation number (o) of the measurement substance flowing passed the vortex sensor, in particular flowing around the sensor lug 112. Furthermore, the converter electronics can advantageously also be configured to compare one or more of the characteristic number values X_{K} each with at least one threshold value TH1, which is determined, for example, in advance under reference conditions or on the basis of the vortex sensor signal s1 and represents a foreign substance proportion specified for the measurement system and/or the measurement substance. The aforementioned threshold value TH1 can correspond, for example, to a (reference) characteristic number value Xₖ (Xₖ@H2O, 25° C.) determined in advance under reference conditions, namely for a, in particular single-phase, calibration fluid flowing through the transducer with predetermined or known Reynolds number, for example, (bubble-free) water, can, for example, correspond to said (reference) characteristic number value Xₖ or be adjusted even during the run time of the measurement system by multiplying such (reference) characteristic number value with a second power (X_{f}²) of a respectively current vortex frequency measurement value X_{f} to the current flow velocity, and/or be selected such as to represent a maximum permissible and/or critical foreign substance proportion. Accordingly, the converter electronics 2 can also be configured to determine the threshold value TH1 on the basis of the vortex sensor signal s1, for example, also on the basis of amplitude measurement values Xₛ determined (under reference conditions) and possibly also on the basis of frequency measurement values X_{f} determined (also under reference conditions), for example, also in the course of (initial) calibration at the manufacturer of the measurement system and/or (re-)calibration on site, and/or the threshold value TH1 in the aforementioned non-volatile memory (EEPROM). Alternatively or additionally, the converter electronics 2 can also be configured to output a message, declared for example, also as an alarm, if one or more of the characteristic number values X_{K} has exceeded the at least one threshold value TH1. The message can be output for example, acoustically and/or visually on site, for example, by means of the aforementioned display element, and/or can be encoded into a data signal transmitted, for example, to the aforementioned data processing system.

In addition, the characteristic number values X_{K} can also be considered, namely for example, included, in the calculation of the flow parameter measurement values X_{M}, in the calculation. Accordingly, the converter electronics 2 are configured to calculate the flow parameter measurement values X_{M} at least in case of a two-phase measurement substance or a measurement substance loaded with foreign substance, in each case also using one or more of the aforementioned characteristic number values X_{K}, in particular in such a way that the flow parameter measurement values X_{M} comply with a calculation rule:

$${X}_{M} = {X}_{K} \cdot {X}_{f}$$

However, alternatively or additionally, the converter electronics 2 can also be configured to calculate the flow parameter measurement values X_{M} at least in case of a two-phase measurement substance or a measurement substance loaded with foreign substance, in each case also directly, using one or more amplitude measurement values Xₛ, in particular in such a way that the flow parameter measurement values X_{M} comply with a calculation rule:

$${X}_{M} = {k}_{M} \cdot \frac{Xs \cdot }{X f}$$

For processing the vortex sensor signal, the converter electronics 2 according to a further embodiment have a first signal filter, for example, designed as a component of the aforementioned converter circuit A/D, which is configured to receive the vortex sensor signal at a signal input and to provide at a filter output a first useful signal containing the first useful component of the vortex sensor signal, but in particular namely always containing the second useful component only in attenuated form or not at all. Furthermore, the converter electronics can also be configured to determine the vortex frequency measurement values X_{f} using said, for example, also digital, first useful signal. Alternatively or additionally, the converter electronics 2 further have a second signal filter, for example, designed as a component of the aforementioned converter circuit A/D, which is configured to receive the vortex sensor signal at a signal input and to provide at a filter output a second useful signal containing the second useful component of the vortex sensor signal, but in particular namely always containing the first useful component only in attenuated form or not at all. Using the, for example, digital, second useful signal, it can also be configured to determine the (resonant) amplitude measurement values Xₛ. Alternatively or additionally, the converter electronics 2 can also be configured to generate a discrete Fourier transform (DFT) and/or an autocorrelation (AKF) of the at least one vortex sensor signal in order then to determine, on the basis of said discrete Fourier transform of the at least one vortex sensor signal or on the basis of said autocorrelation (AKF) of the at least vortex sensor signal, one or more of the vortex frequency measurement values X/and/or one or more of the (resonant) amplitude measurement values Xₛ.

1-14. (canceled)

15. A measurement system for measuring at least one time-variable flow parameter of a measurement substance flowing in a pipeline, the measurement system comprising:
a pipe defining a lumen, configured to be insertable into a course of the pipeline, and configured to guide the measurement substance flowing in the pipeline or to enable the measurement substance to flow therethrough;
a prismatic or cylindrical bluff body arranged in the lumen of the pipe and configured to generate vortices in the measurement substance flowing passed at a shedding frequency dependent on a current flow velocity of the measurement substance such that a Kármán vortex street is formed in the fluid flowing downstream of the bluff body;
a vortex sensor arranged downstream of the bluff body,
which has at least one mechanical resonant frequency, which is a lowest, and/or always above, the shedding frequency, and
which is configured, in a manner excited by the flowing measurement substance, to effect mechanical oscillations around a static rest position and to provide at least one electrical or optical, vortex sensor signal, which at least one vortex sensor signal:
represents the oscillations;
includes a first spectral component representing oscillations of the vortex sensor with the shedding frequency, the first spectral component having a signal level not below a predetermined first threshold value for signal noise; and
includes a second spectral component representing resonance oscillations of the vortex sensor with the mechanical resonance frequency thereof, the second spectral component having a signal level not below a predetermined second threshold value for signal noise; and
converter electronics including at least one microprocessor and configured to evaluate the at least one vortex sensor signal and to determine measurement values for the at least one flow parameter,
wherein the converter electronics are configured to receive and evaluate the at least one vortex sensor signal, including to determine at least:
vortex frequency measurement values representing the shedding frequency based on the first spectral component of the at least one vortex sensor signal; and
amplitude measurement values that represent an amplitude of the resonance oscillations of the vortex sensor based on the second spectral component, and
wherein the converter electronics are further configured:
using one or more amplitude measurement values, to determine:
whether and/or to what extent the measurement substance contains a foreign substance; and/or
whether the measurement substance is embodied as a single-phase or multi-phase substance; and
using one or more vortex frequency measurement values, to calculate flow parameter measurement values, which are measurement values for the at least one flow parameter, such that the flow parameter measurement values each comply with a calculation rule, as follows:
$${X}_{M} = {k}_{M} \cdot {X}_{f}$$

16. The measurement system according to claim 15, wherein the converter electronics are configured to calculate the flow parameter measurement values also using a Strouhal number, which is a characteristic number representing a ratio of the shedding frequency to the flow velocity of the fluid flowing passed the bluff body.

17. The measurement system according to claim 15, wherein the converter electronics are configured to calculate the flow parameter measurement values, at least in case of a two-phase measurement substance, in each case also using one or more amplitude measurement values, such that the flow parameter measurement values comply with a calculation rule, as follows:
$${X}_{M} = {k}_{M} \cdot \frac{Xs \cdot }{X f}$$

18. The measurement system according to claim 15, wherein the converter electronics are configured to calculate, using at least one of the amplitude measurement values and at least one of the vortex frequency measurement values, a characteristic number value for a flow characteristic characterizing a ratio of a static pressure acting on the vortex sensor in a direction extending transversely to an imaginary longitudinal axis of the measurement pipe to a dynamic pressure acting on the vortex sensor in the direction of the imaginary longitudinal axis of the measurement pipe, such that:
the characteristic number value complies with a calculation rule, as follows:
$${X}_{K} = {k}_{K} \cdot \frac{Xs \cdot }{{X}_{f}^{2}}$$
and/or
the flow characteristic corresponds to a pressure coefficient of the vortex sensor, an Euler number, or a cavitation number of the measurement substance.

19. The measurement system according to claim 18, wherein the converter electronics are configured to compare the characteristic number value with at least one threshold value, determined in advance under reference conditions and/or on the basis of the vortex sensor signal, which threshold value represents a maximum permissible and/or critical foreign substance proportion specified for the measurement system and/or the measurement substance.

20. The measurement system according to claim 19, wherein at least one of:
the converter electronics are configured to determine the at least one threshold value based on the vortex sensor signal by using at least one of the vortex frequency measurement values;
the at least one threshold value corresponds to a characteristic number value determined in advance under reference conditions for a calibration fluid which flows through the transducer; and
the converter electronics are configured to output a visually and/or auditorily perceivable on site, encoded into a data signal, and/or declared as an alarm, when the characteristic number value has exceeded the at least one threshold value.

21. The measurement system according to claim 15, wherein:
the converter electronics include a first signal filter configured to receive the vortex sensor signal at a signal input and to provide at a filter output a first useful signal including the first spectral component of the vortex sensor signal and the second useful component only in attenuated form or not at all; and/or
the converter electronics include a second signal filter configured to receive the vortex sensor signal at the signal input and to provide at the filter output a second useful signal including the second spectral component of the vortex sensor signal and including the first spectral component only in attenuated form or not at all.

22. The measurement system according to claim 21, wherein:
the converter electronics are configured to determine the vortex frequency measurement values using the first useful signal; and/or
the converter electronics are configured to determine the amplitude measurement values using the second useful signal.

23. The measurement system according to claim 15, wherein the converter electronics are configured:
to generate a discrete Fourier transform of the at least one vortex sensor signal; and
to determine the vortex frequency measurement values and/or the amplitude measurement values based on the discrete Fourier transform of the at least one vortex sensor signal.

24. The measurement system according to claim 15, wherein the converter electronics are configured:
to calculate an autocorrelation of the at least one vortex sensor signal; and
to determine the vortex frequency measurement values based on the autocorrelation of the at least one vortex sensor signal.

25. The measurement system according to claim 15, wherein the converter electronics include at least one converter circuit configured to receive and digitize the at least one vortex sensor signal and to provide the digital vortex sensor signal at a digital output of the converter circuit.

26. The measurement system according to claim 15, wherein the vortex sensor comprises:
a membrane-like and/or disk-shaped deformation element including a first surface facing the lumen and an opposite second surface, which is at least partially parallel to the first surface; and
at least one transducer element arranged above, on, and/or in the vicinity of the second surface of the deformation element, which at least one transducer element is configured to detect movements of the deformation element and to convert the movements into the vortex sensor signal.

27. The measurement system according to claim 26, wherein the vortex sensor includes a planar or wedge-shaped sensor lug extending from the first surface of the deformation element to a distal end.

28. The measurement system according to claim 15, further comprising a display element coupled to the converter electronics and adapted to output measurement values provided by the converter electronics for the at least one flow parameter and/or to output messages generated by the converter electronics.

29. The measurement system according to claim 15, wherein the at least one flow parameter is a flow velocity, volume flow rate, and/or a mass flow rate of the measurement substance flowing in the pipeline.

30. The measurement system according to claim 15, wherein the measurement substance flowing in the pipeline is an at least occasionally single-phase and/or at least occasionally multi-phase fluid measurement substance.

31. The measurement system according to claim 15, wherein the measurement substance flowing in the pipeline is a gas, a liquid, or a dispersion.

32. The measurement system according to claim 15, wherein the foreign substance is gas inclusions entrained in a liquid phase of the measurement substance.
